(19) United States
(12) Patent Application Publication
(10) Pub. No.: US 2012/0254717 A1
(43) Pub. Date: Oct. 4, 2012

(54) MEDIA TAGGING

(76) Inventors: Prasenjit Dey, Bangalore (IN); Sriganesh Madhvanath, Bangalore (IN); Praphul Chandra, Bangalore (IN); Ramadevi Vennelakanti, Bangalore (IN); Pooja A, Bangalore (IN)

(21) Appl. No.: 13/358,373

(22) Filed: Jan. 25, 2012

(30) Foreign Application Priority Data
Mar. 29, 2011 (IN) 986/CHE/2011

(51) Int. Cl. G06F 17/00

(52) U.S. Cl. 715/230

(57) ABSTRACT

Provided is a method of tagging media. The method identifies at least one region of interest in a media based on a user input and assigns a higher weighted tag to an object identified in at least one region of interest compared to an object present in another region of the media.

### BACKGROUND

More often than not, people like to build a collection of media they might have acquired or created over the years. It could be a collection of photographs, audio tracks, movies, newspaper or magazine clippings, books, and the like. A media acquired from another source, such as, a store, would typically carry information about itself. For example, a book purchased from a vendor might contain details, such as, its title, author's name, publisher's address, price, etc. Similarly, a compact disc (CD) containing a collection of audio tracks might carry information related to artist(s), composers, musicians, orchestra, etc. Such details act as tags that help in subsequent identification or categorization of a media.

In case a media is created by a user, the onus of providing suitable labels or tags typically vests with the author. An author may employ different means to label a media. For example, if it's a printed photograph, a user may choose to provide relevant details (such as, when it was taken, place it was taken, etc.) by writing a note on the back of the photograph. In case, a photo is in digital format, similar details may be provided by assigning an appropriate file name along with other recognizable details. In both scenarios, the process of labeling or tagging requires an explicit action from a user, which may not be always desirable.

### BRIEF DESCRIPTION OF THE DRAWINGS

For a better understanding of the solution, embodiments will now be described, purely by way of example, with reference to the accompanying drawings, in which:

FIG. 1 shows a flow chart of a computer-implemented method of tagging media according to an embodiment.

FIGS. 2A and 2B show aspects of the method of FIG. 1 according to an embodiment.

FIG. 3 shows another aspect of the method of FIG. 1 according to an embodiment.

FIG. 4 shows a block diagram of a user's computing system according to an embodiment.

### DETAILED DESCRIPTION OF THE INVENTION

Media tagging typically requires an explicit input from a user. A user is expected to generate tags that might help him or her in future identification or use of the media. For example, if a user wants to recall details related to a collection of birthday photographs at a later date, he or she may be required to add appropriate tags (such as birthday date, location of the party, people present during the event, etc.) to the collection as such, or to each photograph individually. Needless to say, this could be annoying to a user, who may not have the time or inclination for such tedious process.

Proposed is solution that provides for implicit tagging of a media. People often interact with others while discussing a media. For example, there may be a scenario when multiple users might view and discuss a photograph together. The discussion may pertain to a large number of topics, such as, when the photograph was taken, who took it, who are the people in the photograph, what objects (e.g. a car) are present, what was being said, and so and so forth. Also, during interaction, there may be some parts, objects, or persons in the photograph that are discussed or referred more often than others probably because they may be more relevant in the context of the photograph. Details such as these, which could be very important to the users, are often lost once the interaction is over. The proposed solution captures such implicit details by combining content in a media with information obtained during a user interaction to identify tags that are more relevant to a user(s).

Embodiments of the present solution provide a method and system for tagging media.

For the sake of clarity, the term “media”, in this document, refers to digital data, object or content. By way of example, and not limitation, “media” may include text, audio, video, graphics, animation, images (such as, photographs), multimedia, and the like.

Also, in this document, the term “user” may include a “consumer”, an “individual”, a “person”, or the like.

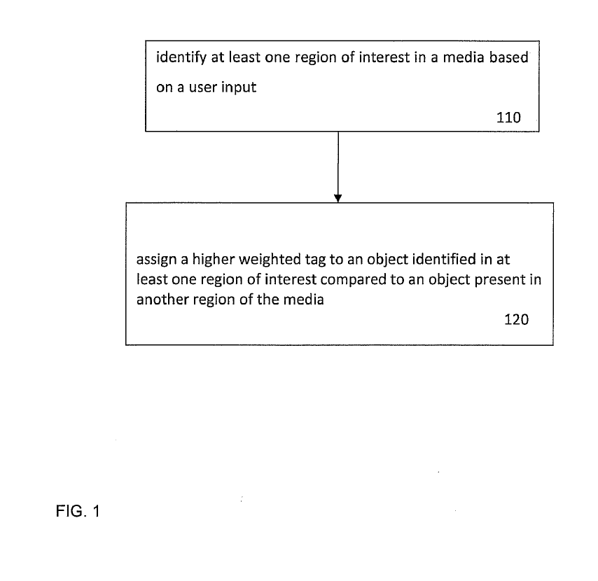

FIG. 1 shows a flow chart of a computer-implemented method of tagging media according to an embodiment.

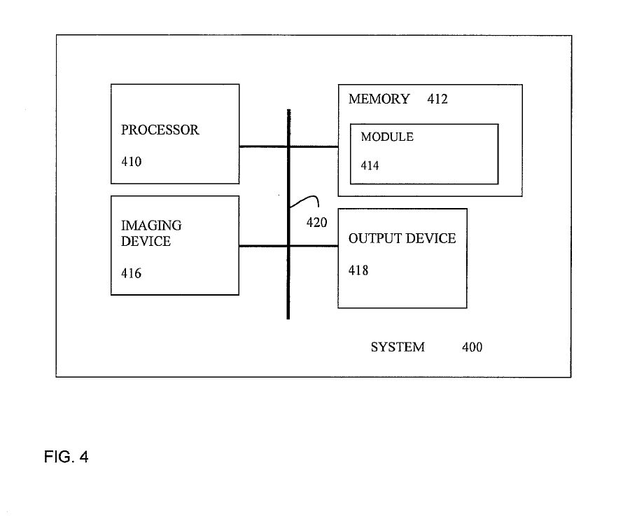

The method may be implemented on a computing device (system), such as, but not limited to, a personal computer, a desktop computer, a laptop computer, a notebook computer, a network computer, a personal digital assistant (PDA), a mobile device, a hand-held device, or the like. A typical computing device that may be used is described further in detail subsequently with reference to FIG. 4.

Additionally, the computing device may be connected to another computing device or a plurality of computing devices via a network, such as, but not limited to, a Local Area Network (LAN), a Wide Area Network, the Internet, or the like.

Referring to FIG. 1, block 110 involves identifying at least one region of interest in a media based on a user input. A region of interest (ROI) refers to a portion of a media which may be of interest to a user or multiple users. It is typically a part of a media which may contain an object(s) which might be of interest to a user. Block 110 involves identification of at least one region of interest (in a media) by a user or multiple users. However, more than one region of interest may also be identified depending on user interaction.

A region of interest (ROI) in a media may be identified in a number of ways. A region of interest may be identified by recognizing at least one user input modality related to the media or to a portion of the media. The input modality of a user is typically directed towards an object(s) identified in a part of the media wherein an identified object(s) is of interest to a user(s). The type of input modality employed by a user(s) may also vary.

In an example, pointing carried out by a user (in relation to a media) may be used as an input modality. Pointing is used to identify a region(s) of interest (ROI) in a media. To provide an illustration, let's consider a scenario where a user is discussing a photograph (displayed on a computing device) with another user or a group of users. During discussion a user may indulge in a lot of pointing which might be directed towards a particular location of the photograph. This could be because of user's interest in an object(s) present in that location. Irrespective of the reason, pointing directed towards a specific location in the photograph indicates a user's interest in that region of the photograph. This is identified as a region of interest.

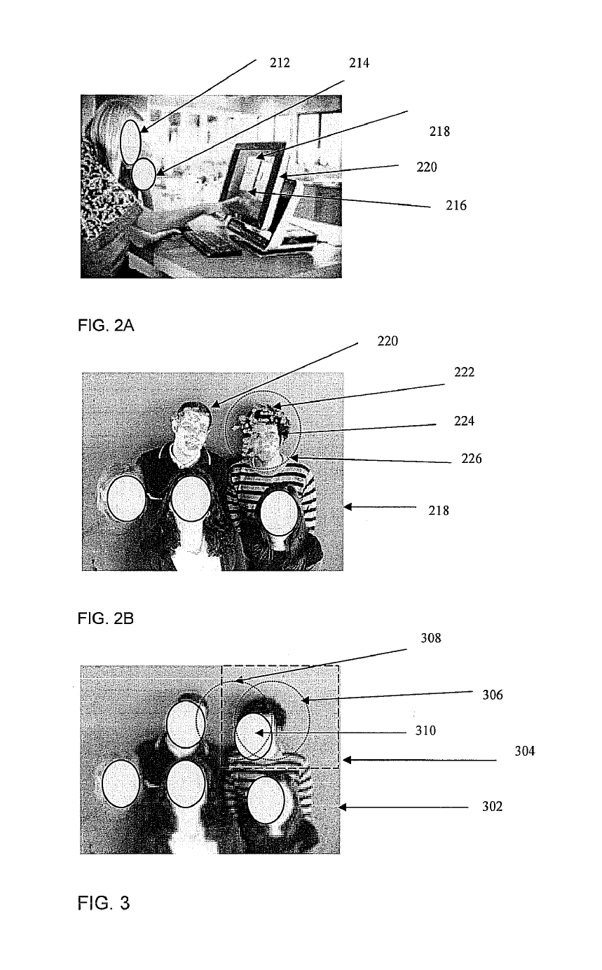

Pointing may be recognized by a detector (comprising an imaging device and a module) present on the computing device which is involved in displaying the media. In an example, pointing may be detected with VVVV toolkit (http://vvvvv.org/) by using colour marker on tip of a finger. A pointing detection module may detect the pointing locations of a user(s) in relation to an image (such as, a photograph). Once the locations are detected, an intensity map of a user's pointing is created on the surface of the image. Adjacent intensity maps are then clustered to create regions of interest (ROI). This is illustrated in FIG. 2B.

In another example, the gaze of a user(s) may be used as an input modality to identify a region of interest in a media. To illustrate, let's assume that a group of users are reading a text document on the display of a computing device. The method may recognize the gaze of each user (using an imaging device and a gaze detection module) to identify portion(s) of the text document which the users have been looking or staring at. Just like the illustration described above for pointing detection, intensity maps of gaze may be created to identify region(s) of interest in the text document.

In a yet another example, the speech of a user(s) may be used as an input modality to identify a region of interest in a media. Regions of interest in a media may be identified by recognizing keywords in the speech of a user(s). To illustrate, let's assume that a group of users are viewing a photograph on a computing device. If a user or users repeatedly refer to a particular area of the photograph, such as, “top right” or “top left”, it indicates that these regions are of interest to a user or users. A detector along with a speech recognition module may be used to recognize keywords, such as, “top right” and “top left”.

In a further example, more than one input modality may be used in combination to identify a region of interest in a media. For example, both speech input and pointing made by a user may be used together to identify a region of interest in a media. In another scenario, gaze and speech input from a user may be used in conjunction to identify a ROI. The ROIs from different modalities can be combined to get a robust estimation of the real ROI in a media.

Once a region(s) of interest (ROI) in a media has been identified, objects present in the ROI are identified as well. For the purpose of this document, an “object” includes both living and non-living entities. By way of illustration, and not limitation, “objects” may include a person, an animal, a car, a mountain, a river, a tree, a bike, etc.

A person in a media may be recognized by a face recognition and detection module. Non-living objects, such as, a car or a bike, may be recognized by an object detector module. In an example, all objects present in a media are identified.

Block 120 involves assigning a higher weighted tag to an object identified in a region of interest compared to an object present in another region of the media. Typically all objects identified in a media are assigned tags. A higher weighted tag is assigned to an object(s) present in a region of interest in comparison to an object(s) present in a non-region of interest. Since a region of interest is a portion of a media which is of interest to a user (as identified in block 110), a higher weighted tag is assigned to an object(s) present in a region of interest to highlight the importance and relevance of the object(s) to a user.

Assigning higher weighted tags to objects present in a region of interest ensures that objects which are more relevant to a user(s) are given more weight compared to relatively less important objects. The relevance of an object to a user may be identified in a number of ways. Some examples, not by way of limitation, may include, how frequently a user refers to an object in his/her speech, how long the gaze of a user is directed to an object in a media, how often a user points to an object of his/her interest in the media, etc. A user's interest in an object present in a media may be identified from the input modality of the user. For example, if the input modality is speech, objects of interest may be identified from key words present in the speech.

To provide an illustration, let's assume that there's a photograph of four individuals: A, B, C and D. It is recognized that A and B were pointed out most by a user(s) and were, therefore, identified to be present in a region of interest, while C and D were recognized as present in other regions of the photograph. In such case, a higher weighted tag may be assigned to A and B as compared to C and D. Per a non-limiting example, tags may be assigned in the following manner.

<subjects> A, B, C, D</subjects>
<relevance> 0.9, 0.9, 0.3, 0.3 </relevance>

Since A and B were pointed to most, it is likely that the photograph is related to some event or context that is relevant to A and B more than the others.

In another example, there may be multiple regions of interest identified in a media. In such case, the regions of interest (and correspondingly objects present in them) are assigned separate weights according to their relevance to a user(s). To illustrate, with the above mentioned example, if A and B were pointed out most by a user(s) but were identified to be present in two separate regions of interest, then based on their relevance to user, A and B may be assigned different weights. Assuming, object A was found to be present in a relatively important ROI as compared to B, and C and D were recognized as present in other regions of the photograph, the tags may be assigned in the following manner.

<subjects> A, B, C, D</subjects>
<relevance> 0.9, 0.7, 0.3, 0.3 </relevance>

To provide another illustration, if two objects (mountain and river) are detected in a landscape photograph, and the user pointing is recognized to be more at the mountain, it is very likely that the photo's context is more about the mountain and not the river next to it. In such case, the following tags may be given:

<subjects> Mountain, River </subjects>
<relevance> 0.9, 0.3 </relevance>

Once objects (in a media) have been assigned weightage based a user input, the weighted tags may be used to appropriately change the weights of the term vectors used for search and retrieval of a media in a collection.

FIGS. 2A and 2B show aspects of the method of FIG. 1 according to an embodiment.

FIG. 2A illustrates two users, a user A 212 and a user B 214, pointing towards a region of interest 216 in an image 218 displayed on a computing device 220. In the present case, the computing device may be a touch screen computer, however, in other instances, the computing device may be a desktop computer, a laptop computer, a notebook computer, a network computer, a personal digital assistant (PDA), a mobile device, a hand-held device, or the like. The computing device may comprise an imaging device (not shown) and a pointing detection module (not shown) to identify a region of interest on a media, such as, the image 218.

FIG. 2B illustrates how a pointing detection module may detect the locations pointed out by a user(s) in relation to an image 218. In this case, a user(s) has pointed towards objects X 220 and Y 222, which are faces of two individuals. Once the locations of a user's pointing are detected, an intensity map 224 of a user's pointing is created on the surface of the image 218. Subsequently, adjacent intensity maps are clustered to create a region(s) of interest (ROI) 226.

FIG. 3 shows another aspect of the method of FIG. 1 according to an embodiment.

FIG. 3 illustrates a scenario where multiple input modalities may be used to identify a region(s) of interest in a photograph 302 (media). In the present case, based on a speech input (“top right”) from a user, a ROI 304 is identified in the “top right” region of the photograph. A second ROI 306 is identified by recognizing the pointing performed by a user in relation to the image. A third ROI 308 is detected by tracking gaze of a user. Once all ROls are identified, the method combines their respective locations on the photograph to identify a real ROI 310. The real ROI 310 may be an overlapping region of the three ROIs. It is expected that the real ROI would be more robust in comparison to individual ROIs 304, 306, 308.

FIG. 4 shows a block diagram of a computing system utilized for the implementation of method of FIG. 1 according to an embodiment.

The system 400 may be a computing device, such as, but not limited to, a personal computer, a desktop computer, a laptop computer, a notebook computer, a network computer, a personal digital assistant (PDA), a mobile device, a hand-held device, or the like.

System 400 may include a processor 410, for executing machine readable instructions, a memory 412, for storing machine readable instructions (such as, a module 414), a detector 416 and an output device 418. These components may be coupled together through a system bus 420.

Processor 410 is arranged to execute machine readable instructions. The machine readable instructions may comprise a module that identifies at least one region of interest in a media based on a user input, and assigns a higher weighted tag to an object identified in at least one region of interest compared to an object present in another region of the media. Processor 410 may also execute modules related to identification of an input modality of a user.

It is clarified that the term “module”, as used herein, means, but is not limited to, a software or hardware component. A module may include, by way of example, components, such as software components, processes, functions, attributes, procedures, drivers, firmware, data, databases, and data structures. The module may reside on a volatile or non-volatile storage medium and configured to interact with a processor of a computer system.

The memory 412 may include computer system memory such as, but not limited to, SDRAM (Synchronous DRAM), DDR (Double Data Rate SDRAM), Rambus DRAM (RDRAM), Rambus RAM, etc. or storage memory media, such as, a floppy disk, a hard disk, a CD-ROM, a DVD, a pen drive, etc. The memory 412 may include a module 414. In an example, the module 414 may be a pointing recognition module that includes machine executable instructions for recognizing pointing carried out by a user. In other examples, the module 414 may be a gaze recognition module, a gesture recognition module and/or a voice recognition module.

Detector 416 may be used to recognize various input modalities of a user(s). Depending upon the input modality to be recognized, the detector 316 configuration may vary. If a visual input modality, such as, a hand movement (pointing, gestures, and the like) or gaze of a user needs to be recognized, the detector may include an imaging device, an appropriate sensor (for example, a pointing sensor, an eye gaze sensor, a gesture recognition sensor, etc.) and a corresponding recognition module (i.e. a pointing recognition module, a gaze recognition module or a gesture recognition module) to detect an input provided by a user. The imaging device may be a separate device, which may be attachable to the computing system 400, or it may be integrated with the computing system 400. In an example, the imaging device may be a camera, which may be a still camera, a video camera, a digital camera, and the like.

If speech input of user(s) needs to be recognized, the detector 416 may comprise a microphone and a voice recognition module.

The output device 418 may include a Virtual Display Unit (VDU) for displaying a media. A user may identify a region(s) of interest in a media by various input modalities, such as, but not limited to, gaze, pointing, gesture, and/or voice.

It would be appreciated that the system components depicted in FIG. 4 are for the purpose of illustration only and the actual components may vary depending on the computing system and architecture deployed for implementation of the present solution. The various components described above may be hosted on a single computing system or multiple computer systems, including servers, connected together through suitable means.

The examples described provide a mechanism for individuals to implicitly tag a media, such as, an image, a video, an audio track, a document, etc. No explicit input of information from users is required to determine a region of interest in a media. More relevant objects are assigned higher weight tags than the less relevant one. This results in better categorization and retrieval of information in a media collection at a later date.

It will be appreciated that the embodiments within the scope of the present solution may be implemented in the form of a computer program product including computer-executable instructions, such as program code, which may be run on any suitable computing environment in conjunction with a suitable operating system, such as Microsoft Windows, Linux or UNIX operating system. Embodiments within the scope of the present solution may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

It should be noted that the above-described embodiment of the present solution is for the purpose of illustration only. Although the solution has been described in conjunction with a specific embodiment thereof, those skilled in the art will appreciate that numerous modifications are possible without materially departing from the teachings and advantages of the subject matter described herein. Other substitutions, modifications and changes may be made without departing from the spirit of the present solution.

1. A computer-implemented method of tagging media, comprising:
identifying at least one region of interest in a media based on a user input; and
assigning a higher weighted tag to an object identified in at least one region of interest compared to an object present in another region of the media.

2. A method according to claim 1, wherein the at least one region of interest contains at least one object of interest to a user of the media.

3. A method according to claim 1, wherein the at least one region of interest in a media is identified from at least one input modality of a user.

4. A method according to claim 3, wherein the at least one input modality is pointing carried out by a user.

5. A method according to claim 3, wherein the at least one input modality is speech of a user.

6. A method according to claim 3, wherein the at least one input modality is gaze of a user.

7. A method of claim 1, wherein the media includes at least one of the following:
an image, a video data, an audio data, an audio-video data and/or a document.

8. A method of claim 1, wherein if multiple regions of interest are identified in a media, then each region and any object present therein is assigned a separate tag.

9. A system, comprising:
a detector to identify at least one region of interest in a media; and
a processor to execute machine readable instructions, the machine readable instructions comprising: a module to assign a higher weighted tag to an object identified in at least one region of interest compared to an object present in another region of the media.

10. A system according to claim 9, wherein the at least one region of interest contains at least one object of interest to a user of the media.

11. A system according to claim 9, wherein the at least one region of interest in a media is identified from at least one input modality of a user.

12. A system according to claim 11, wherein if multiple regions of interest are identified from multiple input modalities of a user, the multiple regions of interest are combined to provide a combined region of interest.

13. A system according to claim 9, wherein the detector includes an imaging device, a sensor and a visual input modality recognition module.

14. A system according to claim 9, wherein the detector includes a microphone and a voice recognition module.

15. A non-transitory computer readable medium on which is stored machine readable instructions, said machine readable instructions, when executed by a processor, implementing a method of tagging media, said machine readable instructions comprising code to:
identify at least one region of interest in a media based on a user input; and
assign a higher weighted tag to an object identified in at least one region of interest compared to an object present in another region of the media.
